(19) United States
(12) Patent Application Publication
(10) Pub. No.: US 2004/0182653 A1
(43) Pub. Date: Sep. 23, 2004

(54) Device for electrically controlling a parking and/or emergency brake

(75) Inventors: Dominique Lerouge, Moirans (FR); Helene Basuyau, Bourgoin Jailleu (FR); Florian Trocme, Seyssins (FR); Christian De Gelis, Muides-Sur-Loire (FR)

Correspondence Address: OLIFF & BERRIDGE, PLC, P.O. BOX 19928, ALEXANDRIA, VA, 22320, US

(73) Assignee: SOCIETE EUROPEENNE DE FABRICATIONS INDUSTRIELLES, Tullins (FR)

(21) Appl. No.: 10/305,074

(22) Filed: Nov. 27, 2002

(30) Foreign Application Priority Data
Nov. 30, 2001 (FR) 01.15666

(51) Int. Cl. F16H 1/00

(52) U.S. Cl. 188/2 D; 74/625

(57) ABSTRACT

This device comprises a frame bearing means actuated by at least one electric motor to exert a pulling action on at least one control member able to move with respect to the frame and intended to be connected to braking means, wherein the pulling means comprise:

at least one pulling pulley which comprises at least one pulley wheel and which is secured to the control member,

a winding drum secured to a drive shaft driven by the electric motor fixed to the frame,

and a flexible pulling member of elongate form, which has two ends, a first end of which is fixed to attachment means secured to the frame, which passes into the pulley and the other end of which is fixed to the winding drum so that the winding of the pulling member onto the drum driven in rotation by the electric motor causes the pulley to turn in the direction of pulling of the control member.

### BACKGROUND OF THE INVENTION

The present invention relates to the technical field of electrical control devices for parking and/or emergency brakes for motor vehicles or the like.

### DESCRIPTION OF THE PRIOR ART

In the above field, it is known practice to employ irreversible electric reduction motor control devices driving a winding drum on which is stored a primary cable which pulls secondary cables directly controlling braking means or parking brake.

In general, the irreversibility of a reduction motor is afforded by an angular-transmission system usually comprising a worm driven directly by the drive shaft and meshing with a toothed wheel for the driving of the winding drum. Irreversibility is then obtained by the particular profile adopted for the driving worm and the teeth of the wheel. This type of transmission or reduction motor is said to be irreversible in that action or force exerted on the winding drum is not able to cause the worm to turn. Thus, as long as the motor that drives the worm is not powered, the winding drum secured to the toothed wheel is blocked from rotating.

Such devices for electrically controlling a parking brake are entirely satisfactory as regards their function of employing and releasing the parking and/or emergency brake. However, the type of transmission adopted for pulling on the primary control cable has the disadvantage of being particularly onerous to produce, in that it entails machined parts with a special profile. In addition, in order to achieve a satisfactory response time, it is necessary to employ a high-power motor which rotates at a relatively high speed, associated with a torque which is also high, which means that, overall, such a device has a relatively high cost price.

Thus has appeared the need to have a novel type of electrical control device for a parking and/or emergency brake, the transmission system of which is less expensive to produce than the worm system and which does not require a high-power electric motor.

### SUMMARY OF THE INVENTION

In order to achieve this objective, the invention relates to a device for controlling at least one parking and/or emergency brake of a motor vehicle or the like, comprising a frame bearing means actuated by at least one electric motor to assert a pulling action on at least one control member able to move with respect to the frame and intended to be connected to braking means. According to the inventions the control device is one wherein the pulling means comprise:

at least one pulling pulley which comprises at least one pulley wheel and which is secured to the control member,

a winding drum secured to a drive shaft driven by the electric motor fixed to the frame,

and a flexible pulling member of elongate form, which has two ends, a first of which is fixed to attachment means secured to the frame, which passes into the pulley and the other end of which is fixed to the winding drum so that the winding of the pulling member onto the drum driven in rotation by the electric motor causes the pulley to turn in the direction of pulling of the control member.

The flexible pulling member may be produced in any appropriate way and, for example, consist of a metal or stranded or unstranded textile cable or alternatively of a piano string for example. According to a preferred embodiment of the invention, the flexible pulling member consists of a belt made, for example, of polyester, of Kevlar or of polyamide. As a preference, use is made of a belt comprising textile fibers, this belt then being woven.

Following various tests, it has become apparent that belts comprising Kevlar fibers offer the best characteristics of resistance to elongation due to tension. However, a metal tape could just as easily be used by way of a belt.

As a preference, the control device according to the invention defines a pulley block with just one return for pulling on the control member. However, according to the invention, the pulling pulley could comprise several pulley wheels to which the same number of pulley wheels of a return pulley, secured to the frame, would then correspond. Thus, the flexible pulling member would run back and forth several times between the return pulley and the pulling pulley before being fixed to the winding drum. Such a system then offers a greater step-down ratio.

According to a preferred feature of the invention, the electric motor is associated with a reversible rotating reducer which comprises the drive shaft bearing the winding drum.

According to another feature of the invention, the control device comprises two electric motors which are coupled for driving the rotation of the drum. This advantageous feature of the invention therefore makes it possible, for the same speed of rotation, to reduce by half the amount of torque needed at each motor. Now, the power of an electric motor is associated in particular with the dimensions of its rotor. Hence, the possibility of employing two lower-power electric motors coupled together makes it possible, for example, to reduce the thickness of the motors used and therefore the overall bulk of the control device.

According to another feature of the invention, the control device also comprises means for blocking the rotation of the drum at least in the direction of an unwinding of the pulling member. These means of blocking the rotation of the drum may be produced in any appropriate way and are either associated directly with the drum or, on the other hand, are associated with the electric motor and, for example, with the spindle for the driving of the latter.

As a preference, the blocking means are operated automatically so as to allow the unwinding of the flexible member wound onto the drum and release of the pulling action exerted on the control member and therefore, ultimately, release of the parking brake or brakes. Of course, the command to unblock may be given in any appropriate way. Hence, it may be envisioned for an electrical command to be given, this being actuated jointly with the powering of the electric motor, so as to obtain unwinding of the flexible member wound onto the drum. However, the means commanding unblocking could just as easily be actuated mechanically by a user of the control device so as, for example, to allow emergency release. Of course, operation of the electric unblocking means may be combined with mechanical unblocking by hand.

According to a preferred but not exclusive embodiment of the intention, the blocking means comprise a gullet-toothed wheel secured to the winding drum or the spindle of the motor. The toothed wheel is then associated with a blocking pawl secured to the frame. The teeth of the wheel incidentally are directed so as to impede rotation of the drum in the direction of unwinding. The electrically controlled operating means then actuate the pawl so as to move it away from the toothed wheel to allow it to rotate in the direction of unwinding. By contrast, the orientation of the teeth of the wheel allows the drum to rotate in the direction of winding even when the pawl is rubbing against the wheel.

As specified above, the blocking means may also be designed to brake or block the rotation of the drive shaft and are then made to unblock when the electric motor is powered.

According to a preferred embodiment of the control device according to the invention, this device comprises means for exerting, by hand, a pulling action on the flexible pulling member. Such operating means therefore make it possible to operate the parking and/or emergency brake even in the event of failure of the electrical power supply or of the electric motor itself.

The operating means may be produced in any appropriate way. Thus, the operating means may consist of an auxiliary drive system secured to the winding drum and driven in rotation from a cranking handle or an emergency key that can be operated by hand.

According to a preferred embodiment, the operating means incorporate means of attaching the flexible pulling member to the frame.

The operating means may then comprise:

a lever which is fixed so as to be able to pivot on the frame and to which one end of the flexible pulling member is fixed,

and reversible means for locking the movement of the lever.

So as to allow correct winding of the flexible pulling member and avoid damage to the latter, the operating means preferably comprise a winding sector which is secured to the operating lever and to which the flexible pulling member is fixed.

Furthermore, in order, as far as possible, to reduce the dead travel of the pulling pulley, resulting, for example, from the appearance of slack due to lengthening of the flexible pulling member or to compaction of the various protective sheaths on the cables controlling the braking means, the invention in a preferred but not strictly necessary embodiment comprises means for pretensioning the flexible pulling member. As a preference, without this being strictly necessary, however, the pretensioning means are designed to maintain this pretension automatically.

Such automatic pretensioning means may be produced in any appropriate way and, for example, incorporated into the means of attachment of one end of the flexible pulling member to the frame. Thus, the automatic pretensioning means may, for example, comprise a slide, guided in translation in a slideway secured to the frame. The pretensioning means also comprise a spring inserted between the slide and the frame and designed to exert a force on the slide in the direction of the pretensioning of the flexible pulling member. The slide is also associated with a non-return system which blocks the movement of the slide when a pulling action, stronger than the one exerted by the spring, is applied to the pulling member by the winding drum for example.

According to another embodiment of the invention, the automatic pretensioning means axe incorporated into the emergency operating means.

In an alternative form of embodiment, the winding sector is then connected to the lever by, on the one hand, a reversible rotational link so that the lever is connected in terms of rotation to the winding sector only in the direction of tensioning of the flexible member. The winding sector is, on the other hand, connected to the operating lever by an elastic return member exerting a force on the winding sector in the direction of tensioning of the flexible pulling member. Thus, when the tension in the flexible pulling member is lower than the force exerted by the spring, the reversible rotational drive means are unblocked and the spring fully exerts its action of tensioning of the flexible pulling member. By contrast, when the force exerted on the flexible pulling member either by the lever or by the winding drum exceeds the pretension exerted by the spring, the reversible rotational drive members are blocked and the winding sector is connected in terms of rotation to the operating lever.

According to another feature of the invention, the control device also comprises means of piloting the operation of the electric motor. The piloting means are designed to control the motor in such a way as, on the one hand, to provide sufficient winding of the flexible pulling member with a view to employing the braking means and, on the other hand, sufficient unwinding of the flexible pulling member to deactivate the braking means.

In order to perform this piloting and, in particular, to interrupt the power supply to the electric motor when the pulling action exerted on the control member is of a certain value, the piloting means preferably but not necessarily comprise means of measuring the pulling action exerted on the control member.

In the same way, in a preferred embodiment, the piloting means also comprise means of measuring the tension in the flexible pulling member. These measurement means may then be used during the phase of unwinding the flexible pulling member so as to avoid relaxing it excessively and therefore creating slack or dead travel which would need to be taken up swiftly during the tensioning of the flexible pulling member. The means of measuring the tension in the flexible pulling member may be produced in any appropriate way such as, for example, using a feeler associated with a circuit breaker or contact switch.

According to another feature of the invention, the piloting means may comprise sensors sensing the position of the pulley so as to control the operation of the electric motor on the basis of the position of this pulley. These position sensors may be produced in any appropriate way such as, for example, in the form of contact switches or alternatively optical sensors.

### BRIEF DESCRIPTION OF THE DRAWINGS

Various other features of the invention will become apparent from the description below, made with reference to the appended drawings which illustrate various nonlimiting embodiments of an electric control device for a handbrake or emergency brake according to the invention.

FIG. 1 is a perspective view of a first embodiment of a brake control device according to the invention.

FIG. 2 is an elevation, viewed from above, of the control device illustrated in FIG. 1.

FIG. 3 is a schematic of an exemplary embodiment of means of measuring the pulling force exerted by the control device according to the invention.

FIGS. 4 and 5 are schematic views of an exemplary embodiment of means for measuring or determining the tension in the flexible pulling member.

FIG. 6 is a schematic view of an exemplary embodiment of means for pretensioning or prestressing the flexible control member to also allow emergency unlocking of the brake commanded by the device according to the invention.

FIG. 7 is a perspective of one embodiment of an electric control device for a parking brake according to the invention, also comprising an operating lever for manual control of the braking.

FIG. 8 is an elevation on VIII-VIII of FIG. 7.

FIG. 9 illustrates another form of embodiment of the means for pretensioning or prestressing the flexible control member, giving automatic compensation for slack.

### DESCRIPTION OF THE PREFERRED EMBODIMENTS

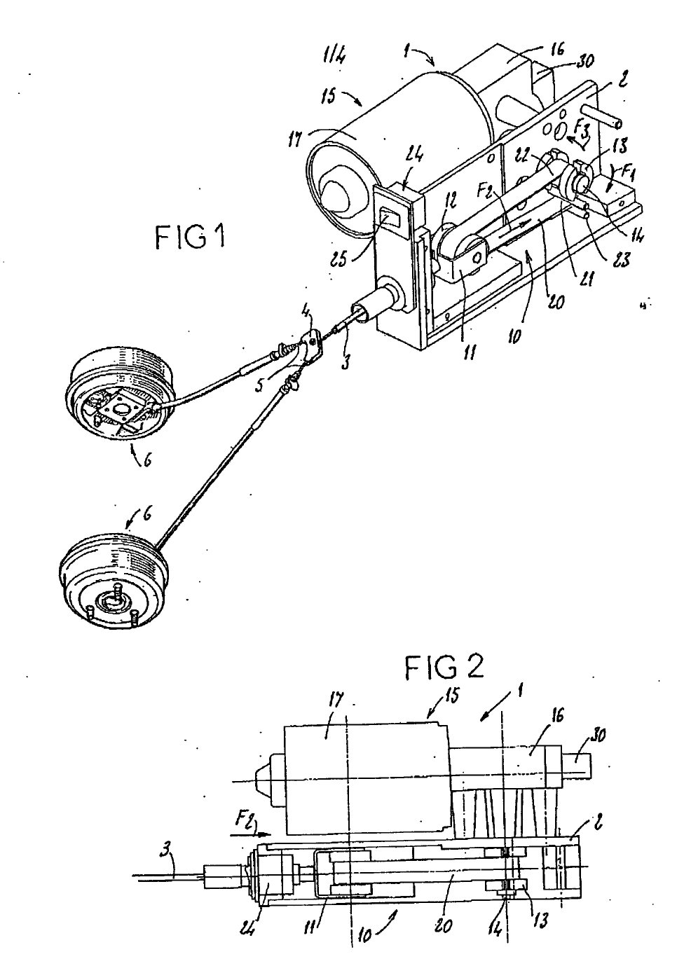

A device for controlling a parking and/or emergency brake of a motor vehicle or the like according to the invention as illustrated in FIGS. 1 and 2 and denoted in its entirety by the reference 1 comprises a frame 2 intended to be fitted to the chassis, not depicted, of a motor vehicle or the like. The control device 1 is therefore suited to exerting a pulling force on at least one control member 3 consisting, according to the example illustrated, of a primary cable secured to a catching balance beam 4 for two secondary cables 5 acting directly on means 6 of braking the wheels of the vehicle. The control member 3 can therefore move in translation at least with respect to the frame 2. Of course, the control member 3 is not necessarily produced in the form of a cable known as a “primary” cable of a parking brake system which could be produced in any other appropriate way such as, for example, in the form of a linkage or of a lever.

To exert a pulling action on the control member 3, the control device 1 according to the invention comprises, by way of pulling means 10, at least one pulling pulley 11 which is secured to the control member 3. The pulley 11 comprises at least one pulley wheel 12 and, according to the example illustrated, just one pulley wheel 12. According to an essential feature of the invention, the pulling means 10 also comprise a winding drum 13 secured to the drive shaft 14 of an electric reduction motor assembly 15 fixed to the frame 2. The reduction motor 15 comprises a reducer 16, preferably of reversible type, associated with an electric motor 17.

The pulling means 10 also comprise a flexible pulling member 20 of elongate form, having two ends 21, 22. According to the example illustrated, the flexible pulling member 20 consists of a belt, preferably made of fabric or woven ribbon, the warp filaments of which contain Kevlar fibers.

One of the ends 21 of the flexible pulling member 20 is first of all fixed to attachment means 23 secured to the chassis 2. The flexible pulling member 20 then passes over the pulley wheel 12 of the pulley 11 to be fixed at its upper end 23 to the winding drum 13.

To operate the electric motor 16, the control device 1 also comprises electric piloting means 24 which, according to the example illustrated, comprise a switch 25 which, for example, but not necessarily, plays a reversing function.

The control device 1 according to the invention, as described hereinabove, works as follows.

When it is desirable to employ the parking brakes, the circuit breaker 25 is actuated to cause the winding drum 13 to rotate in the direction of the arrow F1. The gradual winding of the belt 20 onto the drum 13 then causes the pulley 11 to move in the direction of the arrow F2, and this exerts a pulling action on the control member 3. It should be noted that the pulling means 10 according to the invention produce a kind of pulley block which adds a degree of stepping-down to that of the reducer 16 which means that the force that the electric motor 17 has to supply in order to exert on the control member 3 a pulling action which is sufficient to operate the emergency brakes is smaller. Use of the flexible pulling member 20 thus makes it possible to obtain a stepping-down, by sheaving, the cost price of which is well below that of a geared reducer system or the like.

The winding of the flexible pulling member 20, when the force exerted on the control member 3 has reached a nominal value, can be stopped in various ways.

According to a first embodiment, the electric motor 17 may be chosen so that it has a maximum torque that corresponds to the nominal value of the force needed at the pulling member 3. The operation of motor 17 is then controlled until the latter is blocked, which blockage is detected by the piloting device 24 which then interrupts the power supply: thereof and commands a blocking of the rotation of the drum 13 by means of a mechanical brake system 30 arranged at the reducer 16. The blocking of the rotation of the drum 13 could also be performed by means of a controlled brake acting on the rotor of the electric motor 17.

The winding of the flexible pulling member may just as easily be stopped by measuring the pulling force exerted on the control member 3.

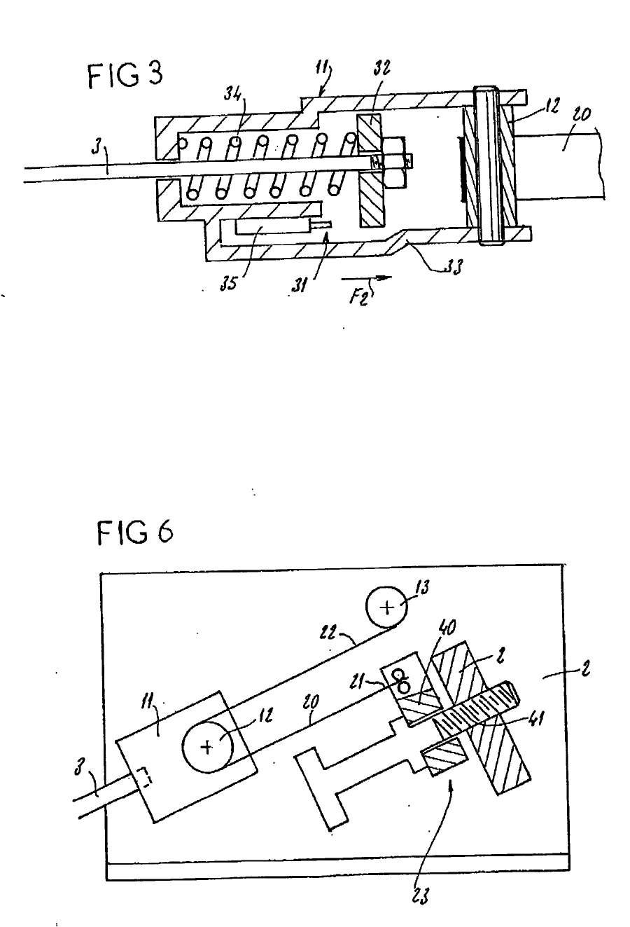

Thus, FIG. 3 illustrates one example of a traction sensor 31 which can be inserted between the control member 3 and the pulley 11. According to this embodiment, the force sensor 31 comprises a slide 32 secured to the control member 3 and able to move in translation inside the body 33 of the pulley 11. The sensor 31 further comprises a helical spring 34 inserted between the slide 32 and the body 33. When a pulling force in the direction of the arrow F2 is exerted on the pulley, the spring 32 compresses until it allows contact between the slide 32 and a circuit breaker 35. The stiffness of the spring 34 is then calculated so that the crushing of the spring, which gives rise to contact between the slide 32 and the circuit breaker 35, corresponds to the nominal force needed for appropriate action of the parking brakes 6 acted upon by the control member 3.

Furthermore, when deactivation of the parking brakes 6 is desired, the circuit breaker 25 is operated to cause the winding drum 13 to rotate in the opposite direction as indicated by the arrow F3. This then yields unwinding of the flexible pulling member 20. It is possible to employ various means to bring about the number of revolutions needed to release the force of the pulling member 20 so as to obtain deactivation of the brakes 6.

According to a first embodiment which has not been depicted, provision is made for use to be made of sensors sensing the position of the pulley 11, which sensors detect its return to its initial position so as to interrupt the operation of the electric motor 17 in terms of unwinding.

However, in certain applications, it may prove desirable not to completely unwind the flexible pulling member 20, so as to leave a certain residual tension or pretension therein. This pretension or prestress then makes it possible to reduce to a minimum the dead travel that needs to be compensated for when actuating the parking brakes.

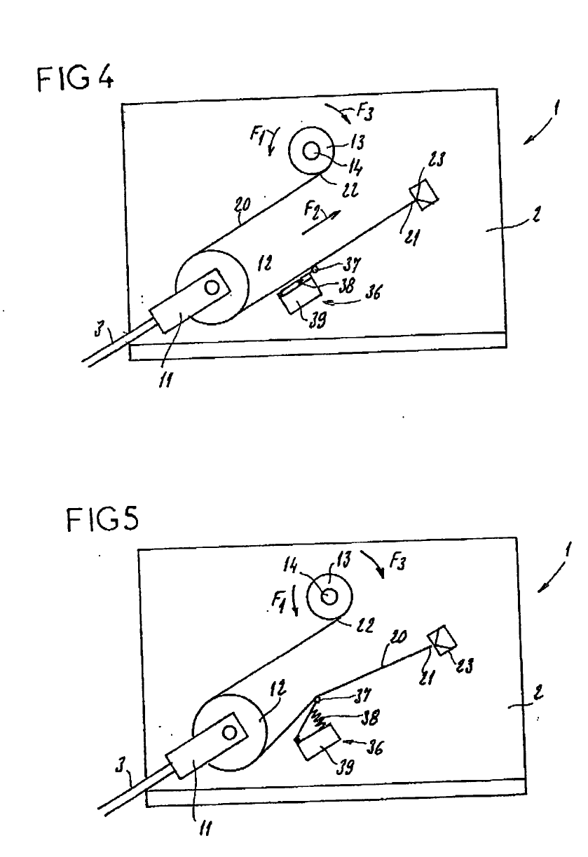

For this, the piloting means 24 comprise means or sensors for measuring the tension in the belt 20. A preferred but not strictly necessary form of embodiment of such sensors 36 is illustrated schematically in FIGS. 4 and 5. Thus, according to this example, the sensor 36 comprises a feeler 37 which presses against the flexible pulling member 20 and which is slaved in extension by a preloaded spring 38. When the tension in the belt 20 decreases, the feeler 36 is then able to push the belt 20 back as shown in FIG. 5 to trigger a contact switch 39 associated with the feeler 37. In this way, it is detected that the tension in the belt has dropped below a predetermined threshold corresponding to the desired pretension and the piloting means then command stoppage of the motor 17 and blockage of the drum 13.

According to the invention, mechanical means may also be provided for pretensioning the flexible pulling member 20 or alternatively for rapidly taking up any slack which may arise as the control device according to the invention is gradually used.

FIG. 6 illustrates one nonlimiting example of a system for taking up slack associated with the means 23 of attachment of the end 22 of the flexible pulling member 20. According to this example, the means of taking up slack comprise a jaw 40 able to move in translation with respect to the frame 2 and connected to the latter by a helical connection afforded by a screw 41. Thus, the turning of the screw 41 makes it possible to move the jaw 40 to some extent closer to the frame 2 and therefore pretension the flexible pulling member 20. In addition it must be noted that the screw 41 is also able to act as an emergency unlocking means in that, by moving the jaw away from the frame, it allows the tension in the flexible pulling member 20 to be released and the parking brakes 6 operated by the device 1 according to the invention therefore to be deactivated.

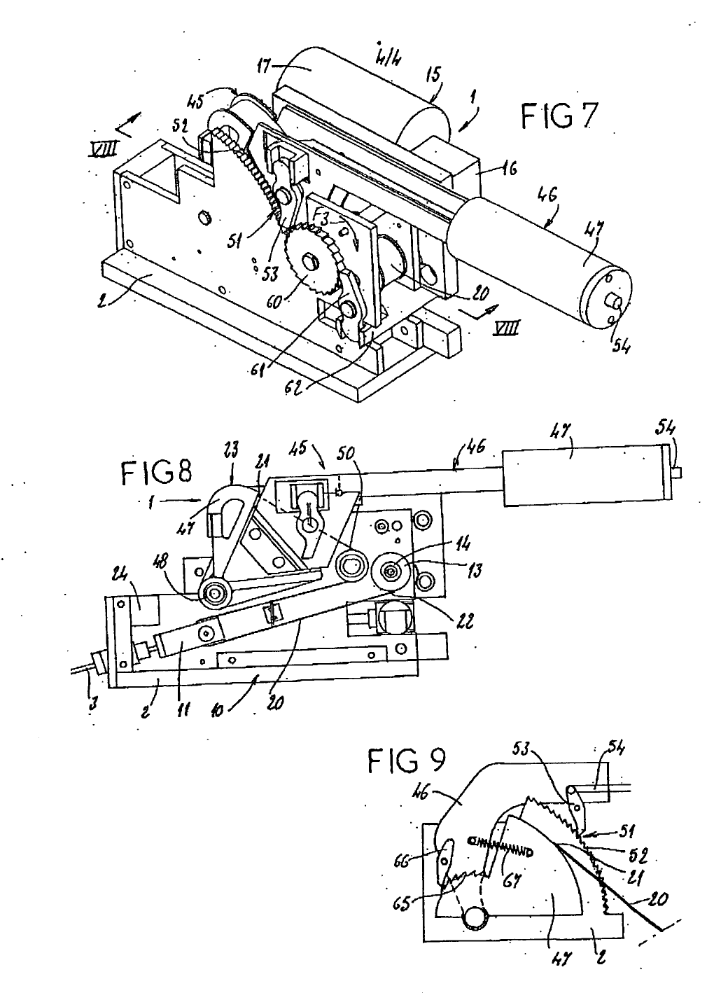

According to the invention, it is also possible to provide operating means, also said to be emergency operating means, allowing the braking means 6 to be operated in the event of a malfunctioning of the electric motor. Thus, FIGS. 7 and 8 illustrate another form of embodiment of a control device 1 according to the invention which comprises such operating means 45 comprising an operating lever 46 intended to be actuated by hand. According to this example, the means 23 of attachment of the end 21 of the flexible pulling member 20 are incorporated into the emergency operating means 45.

Thus, the operating means 45 comprise the lever 46 equipped with a handle 47. The lever 46 is secured to a winding sector 47 which is fixed to the frame 2 by a pivot 48. The control device 1 further comprises a return pulley 50 secured to the frame 2 and over which the flexible pulling member 20 passes before being attached by its end 21 to the winding sector 47.

It must be pointed out that the presence of such a winding sector 47 is not strictly necessary and that the flexible pulling member 20 could be attached directly to the lever 46. However, the winding sector 47 very advantageously makes it possible to keep the radius of application of the pulling force to the flexible member 20 by the lever 46 constant.

According to the example illustrated, means 51 for reversibly locking the movement of the lever 46 are also provided. As shown more particularly in FIG. 7, these reversible locking means 51 are produced according to a known technique for handbrake levers. Thus, the means 51 comprise a toothed sector 52 secured to the frame 2, against which there bears a disengageable pawl 53 secured to the lever 46 so as to keep the latter in the raised position. The operating lever 46 also incorporates a control 54 intended to operate the pawl 52 to cause it to escape from the sector 52 and allow a lowering of the lever.

Furthermore, as also shown by FIG. 7, the device comprises, by way of means of blocking the rotation of the drum 13, a gullet-tooth wheel 60 associated with a blocking pawl 61. The teeth of the wheel 60 axe oriented in such a way as to impede rotation of the drum 13 in the direction of unwinding of the flexible pulling member 20 as indicated by the arrow F3. The pawl 61 is also associated with electrically controlled operating means 62 actuating the pawl 61 in such a way as to move it away from the toothed wheel 60 to allow unwinding of the flexible pulling member 20. The pawl is then slaved in terms of work position by a torsion spring, not depicted. The means 62 of controlling the pawl are controlled by the piloting means 24 with which the control device 1 according to the invention is equipped.

It must be pointed out that, according to this second embodiment illustrated in FIGS. 7 and 8, it is possible to operate the braking means 6 of the vehicle equipped with the device 1 according to the invention either using the operating lever 46 or employing the electric motor 17. Such an arrangement therefore has the advantage of affording a high level of safety and of allowing the parking brakes 6 to be applied under all circumstances.

FIG. 9 illustrates an alternative form of embodiment of the coupling between the winding sector 47 and the lever 46, incorporating means of pretensioning the flexible pulling member 20. According to this exemplary embodiment, the winding sector 47 is connected to the lever 46 by a reversible rotational link produced in the form of a toothed sector 65 formed on the winding sector 47 and collaborating with a pawl 66 borne by the lever 46. The teeth of the toothed sector 65 and the pawl 66 are then oriented in such a way that the winding sector 47 is connected to the lever 46 only in the direction of pulling of the flexible member 20. Furthermore., the winding sector 47 is connected to the lever 46 by an elastic return member 67 exerting a force on the winding sector 47 in the direction of tensioning of the flexible pulling member 20.

Of course, the means of pretensioning the flexible pulling member could be produced in any other appropriate manner.

Furthermore, various modifications can be made to the device for controlling the parking brake without departing from the scope of the invention.

1. A device for controlling at least one parking and/or emergency brake of a motor vehicle or the like, of the type comprising a frame bearing means actuated by at least one electric motor to assert a pulling action on at least one control member able to move with respect to the frame and intended to be connected to braking means, wherein the pulling means comprise:
at least one pulling pulley which comprises at least one pulley wheel and which is secured to the control member,
a winding drum secured to a drive shaft driven by the electric motor fixed to the frame,
and a flexible pulling member of elongate form, which has two ends, a first end of which is fixed to attachment means secured to the frame, which passes into the pulley and the other end of which is fixed to the winding drum so that the winding of the pulling member onto the drum driven in rotation by the electric motor causes the pulley to turn in the direction of pulling of the control member.

2. The control device as claimed in claim 1, wherein the flexible pulling member consists of a belt.

3. The control device as claimed in claim 2, wherein the belt comprises textile fibers.

4. The control device as claimed in claim 2 or 3, wherein the belt comprises Kevlar fibers.

5. The control device as claimed in one of claims 1 to 4, wherein a reducer, able to rotate reversibly, provides the driving of the drum by the electric motor.

6. The control device as claimed in one of claims 1 to 5, and which comprises two electric motors which are coupled for driving the rotation of the drum.

7. The control device as claimed in one of claims 1 to 6, and which comprises means for blocking the rotation of the drum at least in the direction of an unwinding of the flexible pulling member.

8. The control device as claimed in claim 7, wherein the blocking means are made to unblock so as to allow the unwinding of the flexible member, wound onto the drum, and release of the pulling action exerted on the control member.

9. The control device as claimed in claim 8, wherein the blocking means comprise:
a toothed wheel, associated with a blocking pawl designed to impede rotation of the drum in the direction of unwinding,
and electrically controlled operating means actuating the pawl so as to move it away from the toothed wheel.

10. The control device as claimed in claim 7, wherein the blocking means brake or block the rotation of the drive shaft and are made to unblock when the electric motor is powered.

11. The control device as claimed in one of claims 1 to 10 and which comprises means for exerting, by hand, a pulling action on the flexible pulling member.

12. The control device as claimed in claim 11, wherein the operating means incorporate means of attaching the flexible pulling member to the frame.

13. The control device as claimed in claim 12, wherein the operating means comprise;
a lever which is fixed so as to be able to pivot on the frame and to which one end of the flexible pulling member is fixed,
reversible means for locking the movement of the lever.

14. The control device as claimed in claim 13, wherein the operating means comprise a winding sector which is secured to the operating lever and to which the flexible pulling member is fixed.

15. The control device as claimed in one of claims 1 to 14 and which comprises means for pretensioning the flexible pulling member.

16. The control device as claimed in claim 15, wherein the pretensioning means are designed to maintain this pretension automatically.

17. The control device as claimed in claim 14, wherein the winding sector is connected to the lever by, on the one hand, a reversible rotational link so that the lever is connected in terms of rotation to the winding sector only in the direction of tensioning of the flexible member and, on the other hand, by an elastic return member exerting a force on the winding sector in the direction of tensioning of the flexible pulling member.

18. The control device as claimed in claim 15 or 16, wherein the pretensioning means are associated with the means of attachment, secured to the frame, of one end of the flexible pulling member.

19. The control device as claimed in one of claims 1 to 18, and which comprises means of piloting the operation of the electric motor, which command unwinding of the flexible pulling member with a view to employing the braking means and sufficient unwinding of the flexible pulling member to deactivate the braking means.

20. The control device as claimed in claim 19, wherein the means of piloting the operation of the electric motor comprise means of measuring the pulling action exerted on the control member.

21. The control device as claimed in claim 19 or 20, wherein the piloting means comprise means of measuring the tension in the flexible pulling member.

22. The control device as claimed in one of claims 19 to 21, wherein the piloting means comprise sensors sensing the position of the pulley.
